(19) United States
(12) Patent Application Publication
(10) Pub. No.: US 2004/0051668 A1
(43) Pub. Date: Mar. 18, 2004

(54) Multi-frequency single-pole flat antenna

(76) Inventor: Yuan-Li Chang, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,041

(22) Filed: Sep. 13, 2002

(51) Int. Cl. H01Q 1/24

(52) U.S. Cl. 343/702; 343/700 MS

(57) ABSTRACT

A multi-frequency, monopole, flat antenna for a portable device. The antenna is made of conductive material. The portable device has an RF module. The antenna has a feeding terminal that connects to the RF module, and a conductor plate. The antenna resonates with EM waves to produce two non-overlapping EM resonant bands. The conductor plate transmits and receives EM waves of three different frequencies. The first frequency is in the first band, and the conductor plate is large enough to cover a bandwidth larger than the difference between the second and third frequencies, which are in the second band.

### BACKGROUND OF INVENTION

1. Field of the Invention

The present invention relates to multi-frequency antennae, and more particularly, the present invention provides a multi-frequency, monopole, flat antenna.

2. Description of the Prior Art

In the modern information age, everybody wishes that at any time, in any place, they could conveniently get useful information. And, wireless technology can transmit signals without a need for fiber or electric cables, making it undoubtedly a great medium for information transfer. With the evolution of new technology, all kinds of handheld wireless devices, such as cellular phones, which are light and convenient, have already become modern man's tools of information exchange.

In the realm of wireless devices, the antenna, which is used to transmit and receive electromagnetic waves, and thus exchange wireless information signals, is undoubtedly one of the most important elements. Particularly, in modern handheld wireless electronics, the antenna must not only be light, thin, short, and small (in order to fit in with the characteristics of the devices they operate in), but they must also be able to work at multiple frequencies, and have an even higher bandwidth. As everyone knows, in order to fully develop wireless communications, wireless signals are modulated to many different frequencies, allowing the modulated wireless signals to be transmitted over different frequency bands, increasing the capacity for wireless transmissions. For example, the Global System for Mobile Communications (GSM) standard has transmission bands around two frequency bands: 900 MHz and 1800 MHz. In order to transmit/receive wireless signals over multiple frequency bands, the antennae of wireless devices naturally must be able to operate at those frequencies. Additionally, with the increasing bit-rate of wireless signal data (often measured in units of bits/second), the bandwidth of the antennae must also increase accordingly.

Please refer to FIG. 1, which is a diagram of a multiple frequency antenna 10 taught in U.S. Pat. No. 6,008,762. The antenna 10 is a planar inverted-F antenna (PIFA), and comprises a conductor plate 14, a ground plate 26, a dielectric substrate 30, a probe 34, and a signal unit 38. The conductor plate 14 has a first conductive arm 18 and a second conductive arm 22.

The antenna 10 is a dual-frequency antenna, which transmits and receives wireless signals through a resonant current produced by the conductor plate 14, where the first conductive arm 18 uses electromagnetic wave resonance to send and receive electromagnetic waves of the first frequency, and likewise, the second conductive arm 22 also uses electromagnetic wave resonance to send and receive electromagnetic waves of the second frequency.

However, the antenna 10 has some limitations in its operation. For example, the distance t between the conductor plate 14 and the ground plate 26 cannot be too short, else the internal high-frequency circuitry of a cellular phone employing the antenna might experience interference. Also, the thickness of the cellular phone using the prior art antenna 10 cannot be arbitrarily small. So, the prior art antenna 10 hampers the design of thin-bodied cellular phones.

### SUMMARY OF INVENTION

Therefore, it is an,objective of the claimed invention to provide a flat multi-frequency monopole antenna that resolves the above-mentioned problems.

According to the claimed invention, the monopole antenna is intended for use in a cellular phone, is made of conductive material, and is electrically connected to an RF module of the cellular phone. The monopole antenna has a feeding terminal connected to the RF module, and a conductive plate. The conductive plate can produce resonance with electromagnetic (EM) waves to produce a first EM resonance band and a second EM resonance band. The first resonance band and the second resonance band are non-overlapping. The conductive plate is used to transmit and receive EM waves of a first resonant frequency, a second resonant frequency, and a third resonant frequency. The first resonant frequency is within the first EM resonance band, and an area of the conductor plate is larger than a specified value, causing a bandwidth of the second EM resonance band to be larger than a frequency difference of the second resonant frequency and the third resonant frequency, and also causing the second resonant frequency and the third resonant frequency to fall within the second EM resonant band.

It is an advantage of the claimed invention monopole antenna that it is flat, making it easy to install, and easily integrated into modern, thin-bodied cellular phones. The antenna is also operable over three major frequency bands.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of a prior art multi-frequency antenna.

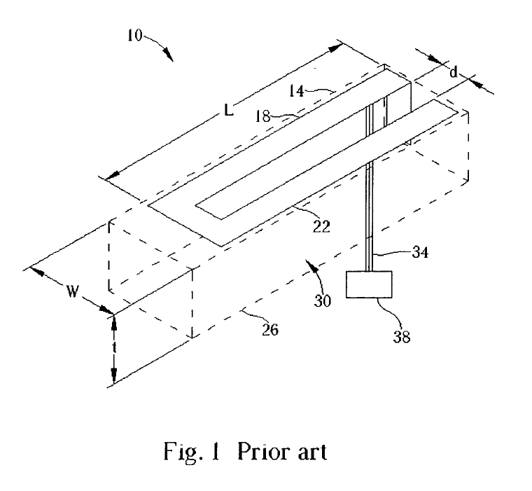

FIG. 2 is a block diagram of a multi-frequency, monopole, flat antenna and a cellular phone according to the present invention.

FIG. 3 is a diagram of the multi-frequency, monopole, flat antenna of FIG. 2 when installed on a housing.

FIG. 4 is a vertical view of the multi-frequency, monopole, flat antenna of FIG. 2.

FIG. 5 is a graph of a reflection coefficient vs. change in frequency of the multi-frequency, monopole, flat antenna of FIG. 2.

FIG. 6 is a diagram of a positioning of the antenna of FIG. 2 in a personal data assistant.

### DETAILED DESCRIPTION

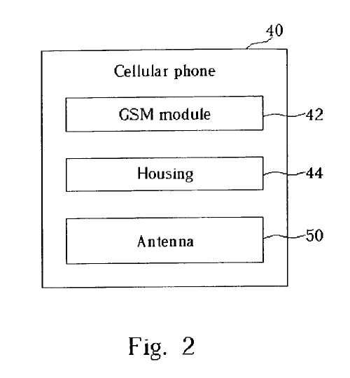

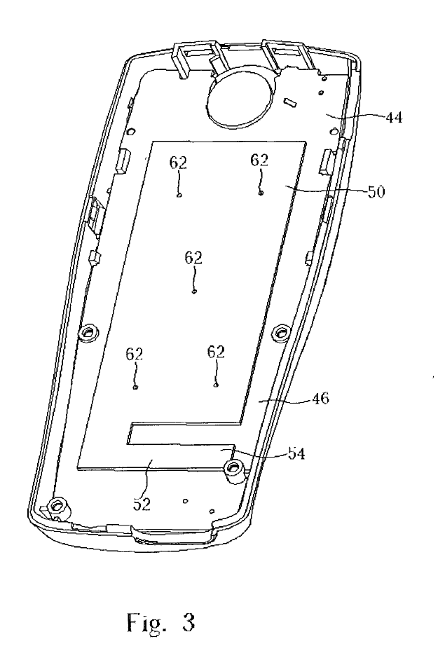

Please refer to FIGS. 2 and 3. FIG. 2 is a block diagram of a multi-frequency, monopole, flat antenna 50, and a cellular phone 40. FIG. 3 is a diagram of the antenna 50 when installed on a housing 44 of the cellular phone 40. The antenna 50 is installed in the cellular phone 40, and electrically connected to an RF module 42 of the cellular phone 40. The RF module 42 can use the antenna 50 to receive and transmit electromagnetic (EM) waves. The antenna 50 is made from a conductive material, and because the antenna 50 is flat, the antenna 50 can be fastened to a flat surface 46 of the housing 44. Therefore, in contrast with the prior art antenna 10, when designing the cellular phone 40 with the present invention antenna 50, it is easy to decrease the thickness of the cellular phone 40, and make more efficient use of the available space in the housing 44. Additionally, in order to securely fasten the antenna 50 on to the flat surface 46, the antenna 50 comprises five permanent screw holes 62. When screws are installed in the five holes 62, the antenna is secured onto the flat surface 46 of the housing 44. When the antenna 50 is securely fastened to the flat surface 46, the antenna 50 can become a fixed part of the cellular phone 40, simplifying the fabrication process.

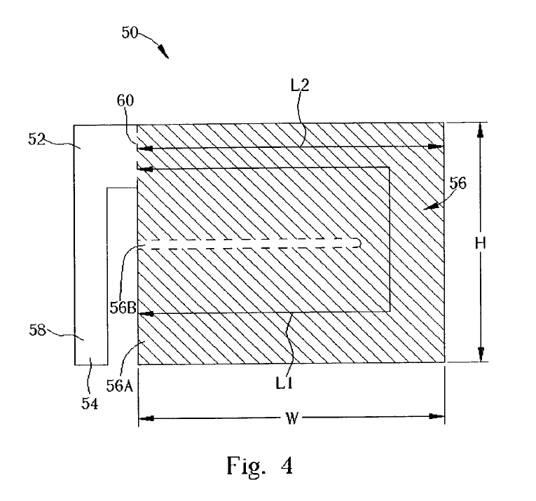

For explanation of the operating principles of the antenna 50, please refer to FIG. 4, which is a vertical view of the multi-frequency, monopole, flat antenna 50, shown in FIG. 2. The antenna 50 comprises a conductor 52, a feeding terminal 54 connected to the RF module of the cellular phone 40, and a conductor surface 56. The conductor 52 is an L-shaped sheet comprising a first end 58 and a second end 60. The first end 58 is connected to the feeding terminal 54, and the second end 60 is connected to the conductor plate 56. The feeding terminal 56 of the antenna 50 is connected to the RF module 42 of the cellular phone 40, and feeds and takes wireless information to and from the RF module 42. The feeding terminal 56 can be designed as a metal piece, and directly connected to the RF module 42. In this manner, the antenna 50 need not be connected to the RF module 42 by a coaxial cable. The conductor plate 56 is a rectangular conductor plate with a width W (approximately 4 cm) and a height H (approximately 2 cm), and can produce resonance with an EM wave. This allows the cellular phone 40 to use the resonance of the antenna 50 to transmit signals in an unlimited fashion.

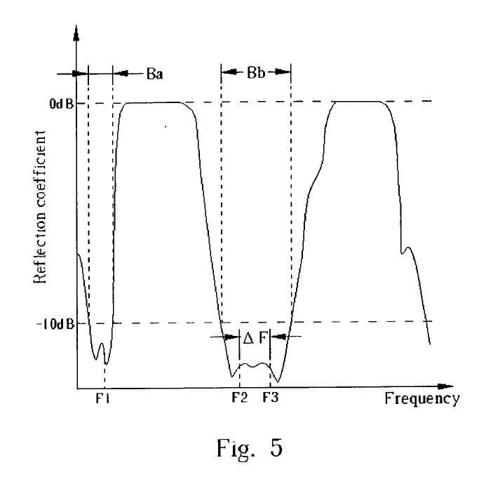

Please refer to FIG. 5, which is a graph of a reflection coefficient vs. frequency for the multi-frequency, monopole, flat antenna 50 of FIG. 2. The vertical axis represents the absolute value of the reflection coefficient, and the horizontal axis represents frequency. The reflection coefficient of the antenna 50 is used to measure the width of the antenna's operating frequency band. Typically, the operating frequency band of an antenna is given by a range of frequencies over which the reflection coefficient is less than 10 dB. As shown in FIG. 5, the antenna 50 produces a first EM resonance band Ba and a second EM resonance band Bb from the EM resonance of the antenna 50. The first EM resonance band Ba and the second resonance band Bb are non-overlapping. The range of the first EM resonance band Ba is 880-960 MHz, and the range of the second EM resonance band Bb is 1710-1930 MHz, thus the antenna 50 is suitable for use in GSM 900, GSM 1800, and GSM 1900 systems.

Please refer again to FIG. 4. The conductor plate 56 is a rectangular plate, and in theory can be seen as having an inverted-C shape, where the conductor 56A has a fine slit 56B represented by dash line. According to principles of electromagnetics, the antenna 50 has a first resonant length L1 and a second resonant length L2. The first resonant length L1 corresponds to the first resonant frequency F1 in the first EM resonant band Ba, and equals ¼ of the wavelength of the first resonant frequency F1. The second resonant length L2 is equal to the width W of the conductor plate 56 between its opposite edges, and equals ¼ of the wavelength of the second resonant frequency F2. The first resonant frequency F1 is within the frequency band agreed upon in the GSM900 system, and the second resonant frequency F2 is within the frequency band agreed upon in the GSM1800 system. Thus, the cellular phone 40 can use the antenna 50 to transmit and receive signals at the first and second resonant frequencies F1,F2 and is suitable for use in GSM900 and GSM1800 systems.

However, in order to make the antenna 50 suitable for use in GSM1900 systems, over and beyond GSM900 and GSM1800, the second EM resonant frequency band Bb must be large enough to cover the combined bandwidths specified for GSM1800 and GSM1900. To achieve this goal, a simple method is to just give the conductor plate 56 a larger area, so that the bandwidth of the second EM resonant band Bb will widen with an increase in the area of the conductor plate 56. Also, because the difference in the bandwidths agreed upon in the specification for GSM1800 and GSM1900 is not very large (GSM1800: 1710-1880 MHz, GSM1900: 1870-1930 MHz), the area of the conductor plate 56 need not be too large, but only sufficiently large to cause the second EM resonance band Bb to cover both the GSM1800 and the GSM1900 bands (1710 MHz 1930 MHz). In other words, in order for the antenna 50 to be suitable for use in GSM900, GSM1800, and GSM1900, the width of the second EM resonance band Bb must be larger than the frequency difference Δ F of the second resonant frequency F2 and a third resonant frequency F3 within the GSM1900 band.

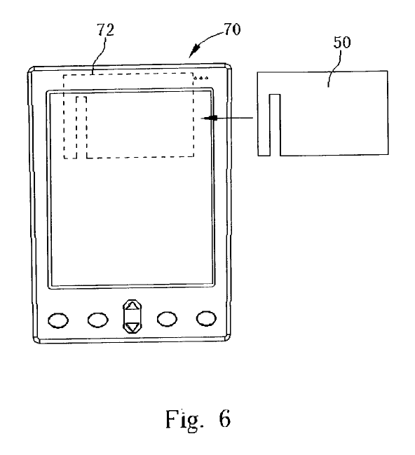

The multi-frequency, monopole, flat antenna 50 not only can be adopted in designing cellular phones but also can be adopted in designing other radio devices, such as a personal data assistant (PDA). Please refer to FIG. 6, which is a diagram of a positioning of the antenna 50 in a PDA 70. The antenna 50 is placed on an installation position 72 of the PDA 70 to transmit and receive electromagnetic waves. The PDA 70 can transmit and receive electromagnetic waves of three different frequencies via the antenna 50 so as to transmit data to and receive data from other radio devices.

Although in the preferred embodiment, the conductor plate 56 of the present invention is a rectangular plate, the conductor plate 56 is not limited to rectangular shape. It should be clear that any antenna using a single conductor plate to simultaneously have a first EM resonance band and a second EM resonance band, and, because the area of the conductor surface is larger than a specified width, causing the width of the second EM resonance band to be larger than the difference of two EM wave frequencies, falls under the teaching of the present invention.

In contrast with the prior art antenna, the present invention multi-frequency, monopole, flat antenna is not only beneficial to the design of thin cellular phones because of its flat exterior, but can also benefit designs that must simultaneously provide coverage of three different cellular system frequency bands.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A multi-frequency monopole antenna for a wireless device, the antenna comprising:
a rectangular first conductor plate having a width between a first edge and a second edge thereof and a height, the first conductor plate producing a first resonance band corresponding to the length from the first edge to the second edge, and producing a second resonance band corresponding to the length from the first edge to the second edge and back to the first edge; and
a second conductor plate connected to the first edge of the first conductor plate for feeding signals of the first resonance band and the second resonance band.

2. The antenna of claim 1, wherein the antenna produces resonance at a first frequency in the first resonance band, the antenna produces resonance at a second frequency in the first resonance band, the antenna produces resonance at a third frequency in the second resonance band.

3. A multi-frequency monopole antenna for a wireless device, the antenna comprising a conductor plate having a first plate portion and a second plate portion, the first plate portion having a width between a first edge and a second edge thereof and a height for producing a first resonance band and a second resonance band, the second plate portion being connected to the first edge of the first plate portion for feeding signals of the first resonance band and the second resonance band, the first plate portion producing the first resonance band corresponding to the length from the first edge to the second edge thereof, and producing the second resonance band corresponding to the length from the first edge to the second edge and back to the first edge.

4. The antenna of claim 3 wherein the second plate portion is L-shaped.

5. The antenna of claim 3 wherein the first plate portion is rectangular.

6. The antenna of claim 3, wherein the antenna produces resonance at a first frequency in the first resonance band, the antenna produces resonance at a second frequency in the first resonance band, the antenna produces resonance at a third frequency in the second resonance band.

7. A multi-frequency monopole antenna for a wireless device, the antenna comprising a conductor plate having a first plate portion and a second plate portion, the first plate portion being retangular with a width between a first edge and a second edge thereof and a height for producing resonance at a first frequency, a second frequency, and a third frequency, the second plate portion being connected to the first edge of the first plate portion for feeding signals of the first frequency, the second frequency, and the third frequency, the first plate portion producing resonance at the first frequency corresponding to a length from the first edge to the second edge thereof, the first plate portion producing resonance at the second frequency corresponding to a length from the first edge to the second edge thereof, and the first plate portion producing resonance at the third frequency corresponding to a length from the first edge to the second edge and back to the first edge.

8. The antenna of claim 5 wherein the conductor is L-shaped.
